(19) United States
(12) Patent Application Publication
(10) Pub. No.: US 2024/0270359 A1
(43) Pub. Date: Aug. 15, 2024

(54) SHIP MONITORING DEVICE, SHIP MONITORING METHOD AND NON-TRANSITORY COMPUTER-READABLE RECORDING MEDIUM

(71) Applicant: Furuno Electric Co., Ltd., Nishinomiya-City (JP)

(72) Inventors: Kazuya NAKAGAWA, Amagasaki (JP); Daisuke MATSUMOTO, Kobe (JP)

(73) Assignee: Furuno Electric Co., Ltd., Nishinomiya-City (JP)

(21) Appl. No.: 18/646,821

(22) Filed: Apr. 26, 2024

Related U.S. Application Data
(63) Continuation-in-part of application No. PCT/JP2022/013012, filed on Mar. 22, 2022.

(30) Foreign Application Priority Data
Oct. 29, 2021 (JP) 2021-177347

(51) Int. Cl. B63B 79/40; B63B 43/18; B63B 49/00

(52) U.S. Cl. CPC B63B 79/40; B63B 43/18; B63B 49/00

(57) ABSTRACT

A ship monitoring device is provided, which includes processing circuitry. The processing circuitry acquires first ship data indicative of a position and a velocity of a first ship. The processing circuitry acquires second ship data indicative of a position and a velocity of a second ship. The processing circuitry determines whether an encounter relationship between the first ship and the second ship is any one of a head-on relationship, a crossing relationship, and an overtaking relationship based on the first ship data and the second ship data. The processing circuitry determines whether at least one of the first ship and the second ship corresponds to a stand-on ship, a give-way ship, or corresponds to neither thereof based on the first ship data, the second ship data, and the encounter relationship.

### CROSS-REFERENCE TO RELATED APPLICATION(S)

This application is a continuation-in-part application of PCT International Application No. PCT/JP2022/013012, which was filed on Mar. 22, 2022, and which claims priority to Japanese Patent Application No. JP2021-177347 filed on Oct. 29, 2021, the entire disclosures of each of which are herein incorporated by reference for all purposes.

### TECHNICAL FIELD

The present disclosure relates to a ship monitoring device, a ship monitoring method, and a program.

### BACKGROUND OF THE DISCLOSURE

JP1992-332893A discloses a collision prevention device which determines whether a ship concerned is a stand-on ship which should maintain the course, or a give-way ship which should give way the course evading from the opponent ship according to the Act on Preventing Collisions at Sea.

However, JP1992-332893A only takes a case where the encounter relationship between this ship and another ship is a crossing relationship into consideration.

### SUMMARY OF THE DISCLOSURE

Thus, the present disclosure is made in view of the above-described problem, and the main purpose thereof is to provide a ship monitoring device, a ship monitoring method, and a program, capable of clarifying a stand-on/give-way determination.

In order to solve the above-described problem, a ship monitoring device according to one aspect of the present disclosure includes a first data acquirer, a second data acquirer, an encounter relationship determinator, and a stand-on/give-way determinator. The first data acquirer acquires first ship data indicative of a position and a velocity of a first ship. The second data acquirer acquires second ship data indicative of a position and a velocity of a second ship. The encounter relationship determinator determines whether an encounter relationship between the first ship and the second ship is any one of a head-on relationship, a crossing relationship, and an overtaking relationship based on the first ship data and the second ship data. The stand-on/give-way determinator determines whether at least one of the first ship and the second ship corresponds to a stand-on ship, a give-way ship, or corresponds to neither thereof based on the first ship data, the second ship data, and the encounter relationship. According to this configuration, it becomes possible to clarify the stand-on/give-way determination.

In the above-described aspect, the stand-on/give-way determinator may determine that the first ship corresponds to a stand-on ship or a give-way ship, when an index indicative of approach of the second ship to the first ship reaches a given criteria. According to this configuration, it becomes possible to clarify the criteria.

In the above-described aspect, the stand-on/give-way determinator may perform the determination using a criteria defined according to a course difference between the first ship and the second ship. According to this configuration, it becomes possible to use the criteria according to the course difference.

In the above-described aspect, the stand-on/give-way determinator may determine that the first ship corresponds to a stand-on ship or a give-way ship, when a time until the second ship crosses a heading line of the first ship, or a time until the second ship approaches the first ship the closest becomes less than a reference period defined according to a course difference between the first ship and the second ship, or when a distance between the first ship and the second ship becomes less than a reference distance defined according to the course difference between the first ship and the second ship. According to this configuration, it becomes possible to clarify the criteria for determining whether the first ship corresponds to a stand-on ship or a give-way ship, or corresponds to neither thereof.

In the above-described aspect, the stand-on/give-way determinator may determine that the first ship corresponds to neither of a stand-on ship and a give-way ship, when the time exceeds the reference period and when the distance exceeds the reference distance. According to this configuration, it becomes possible to clarify the criteria for determining whether the first ship corresponds to a stand-on ship or a give-way ship.

In the above-described aspect, at least one of the reference period and the reference distance may increase with an increase in the course difference within at least a part of the whole range of the course difference. According to this configuration, the first ship may be more likely to be determined to be a stand-on ship or a give-way ship as the course difference increases.

In the above-described aspect, the stand-on/give-way determinator may determine that the first ship corresponds to a give-way ship, when the encounter relationship is the head-on relationship, or is the crossing relationship in which the first ship sees the second ship at the starboard side, and the time becomes less than the reference period or the distance becomes less than the reference distance. According to this configuration, it becomes possible to clarify the criteria for determining whether the first ship corresponds to a give-way ship.

In the above-described aspect, the stand-on/give-way determinator may determine that the first ship corresponds to a stand-on ship, when the encounter relationship is the overtaking relationship, or is the crossing relationship in which the first ship sees the second ship at the port side, and the time becomes less than the reference period or the distance becomes less than the reference distance. According to this configuration, it becomes possible to clarify the criteria for determining whether the first ship corresponds to a stand-on ship.

In the above-described aspect, the stand-on/give-way determinator may determine that the first ship corresponds to a give-way ship, when the encounter relationship is the overtaking relationship, or is the crossing relationship in which the first ship sees the second ship at the port side, and the time becomes less than another reference period shorter than the reference period or the distance becomes less than another reference distance shorter than the reference distance. According to this configuration, it becomes possible to change the determination result of the first ship from a stand-on ship to a give-way ship, when the second ship is determined to be a give-way ship but does not avoid the course.

In the above-described aspect, the ship monitoring device may further include a navigation controller which navigates the first ship so that the velocity of the first ship is maintained, when the first ship is determined to be a stand-on ship. According to this configuration, it becomes possible to perform stand-on navigation of the first ship.

In the above-described aspect, the ship monitoring device may further include a navigation controller which navigates the first ship so that the first ship avoid the course of the second ship, when the first ship is determined to be a give-way ship. According to this configuration, it becomes possible to perform give-way navigation of the first ship.

In the above-described aspect, the ship monitoring device may further include a notice transmitter which notifies the determination result to the second ship, when the first ship is determined to be a stand-on ship or a give-way ship. According to this configuration, it becomes possible to share the determination result.

In the above-described aspect, the second ship data may be generated based on data detected by a radar, an AIS, or a camera mounted on the first ship. According to this configuration, it becomes possible to generate the second ship data using an apparatus mounted on the first ship.

A ship monitoring method according to another aspect of the present disclosure includes acquiring first ship data indicative of a position and a velocity of a first ship, acquiring second ship data indicative of a position and a velocity of a second ship, determining, based on the first ship data and the second ship data, whether an encounter relationship between the first ship and the second ship is any one of a head-on relationship, a crossing relationship, and an overtaking relationship, and determining, based on the first ship data, the second ship data, and the encounter relationship, whether at least one of the first ship and the second ship corresponds to a stand-on ship, a give-way ship, or neither thereof. According to this configuration, it becomes possible to clarify the stand-on/give-way determination.

A non-transitory computer-readable recording medium storing a program according to another aspect of the present disclosure causes a computer to execute processing which includes acquiring first ship data indicative of a position and a velocity of a first ship, acquiring second ship data indicative of a position and a velocity of a second ship, determining, based on the first ship data and the second ship data, whether an encounter relationship between the first ship and the second ship is any one of a head-on relationship, a crossing relationship, and an overtaking relationship, and determining, based on the first ship data, the second ship data, and the encounter relationship, whether at least one of the first ship and the second ship corresponds to a stand-on ship, a give-way ship, or neither thereof. According to this configuration, it becomes possible to clarify the stand-on/give-way determination.

### BRIEF DESCRIPTION OF DRAWINGS

The present disclosure is illustrated by way of example and not by way of limitation in the figures of the accompanying drawings, in which like reference numerals indicate like elements and in which:

FIG. 1 is a view illustrating one example of a configuration of a ship monitoring system;

FIG. 2 is a view illustrating one example of a configuration of a ship monitoring device;

FIG. 3 is a table illustrating one example of an other-ships management database;

FIG. 4 is a view illustrating various encounter relationships;

FIG. 5 is a table illustrating various relationships between a stand-on ship and a give-way ship;

FIG. 6 is a view illustrating positive/negative of a course difference;

FIG. 7 is a graph illustrating various relationships between the course difference and reference periods;

FIG. 8 is a view illustrating a relationship between the course difference and the reference periods;

FIG. 9 is a graph illustrating various relationships between the course difference and reference distances;

FIG. 10 is a view illustrating a relationship between the course difference and the reference distance;

FIG. 11 is a flowchart illustrating one example of a procedure of a ship monitoring method; and

FIG. 12 is a flowchart following FIG. 11.

### DETAILED DESCRIPTION OF THE DISCLOSURE

Hereinafter, one embodiment of the present disclosure is described with reference to the accompanying drawings.

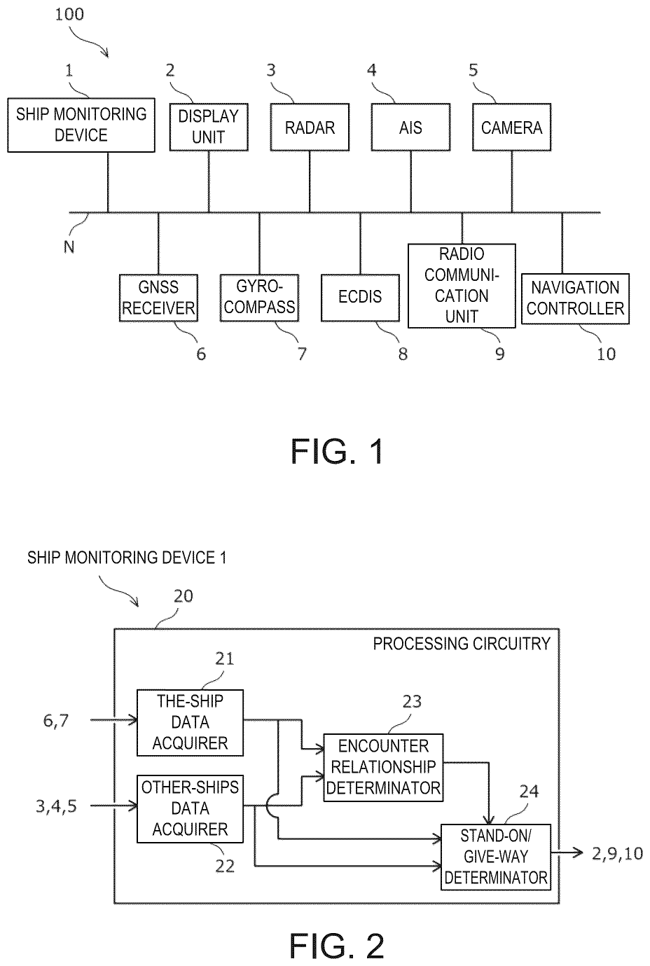

FIG. 1 is a block diagram illustrating one example of a configuration of a ship monitoring system 100. The ship monitoring system 100 may be a system mounted on a ship. Hereinafter, the ship on which the ship monitoring system 100 is mounted is referred to as “the ship,” and ship(s) other than the ship is referred to as “another ship” or “other ships.” Further, “velocity” is a vector quantity indicative of a traveling speed (ship speed) and a heading of a ship, and “ship speed” is a scalar quantity.

The ship monitoring system 100 may include a ship monitoring device 1, a display unit 2, a radar 3, an AIS 4, a camera 5, a GNSS receiver 6, a gyrocompass 7, an ECDIS 8, a radio communication unit 9, and a navigation controller 10. These apparatuses may be connected to a network N, such as a LAN, so that mutual network communications are possible.

The ship monitoring device 1 may be a computer including a CPU, a RAM, a ROM, a nonvolatile memory, and an input/output interface. The CPU of the ship monitoring device 1 may perform information processing according to a program loaded to the RAM from the ROM or the nonvolatile memory.

The program may be supplied via an information storage medium, such as an optical disc or a memory card, or may be supplied via a communication network, such as the Internet or the LAN.

The display unit 2 may display an image for indication generated by the ship monitoring device 1. The display unit 2 may display a radar image, a camera image, or an electronic nautical chart.

The display unit 2 may be, for example, a display device with a touch sensor (so-called “touch panel”). The touch sensor may detect a location instructed in the screen by a user's finger etc. Alternatively, the instructed location may be inputted by a trackball etc.

The radar 3 may emit a radio wave around the ship, receive a reflection wave thereof, and generate echo data based on the reception signal. Further, the radar 3 may discriminate a target object from the echo data, and generate Target-object Tracking data (TT data) indicative of a position and a velocity of the target object.

The AIS (Automatic Identification System) 4 may receive AIS data from another ship which exists around the ship, or a land control. A VDES (VHF Data Exchange System) may be used, instead of AIS. The AIS data may contain an identification signal, a ship name, a position, a course, a ship speed, a ship type, a ship length, and a destination of another ship.

The camera 5 may be a digital camera which images outside the ship to generate image data. The camera 5 may be installed on the ship's bridge so that it is oriented to the bow direction (heading), for example. The camera 5 may be a camera having a pan-tilt function and an optical zoom function (so-called “PTZ camera”).

Further, the camera 5 may also include an image recognition part which estimates a position and a classification of the target object (e.g., a ship) included in the captured camera image by using an object detection model. The image recognition part may be realized in another device, such as the ship monitoring device 1, instead of the camera 5.

The GNSS receiver 6 may detect the position of the ship based on the radio wave received from a GNSS (Global Navigation Satellite System). The gyrocompass 7 may detect the heading of the ship. A GPS compass may be used, instead of the gyrocompass.

The ECDIS (Electronic Chart Display and Information System) 8 may acquire the position of the ship from the GNSS receiver 6, and display the position of the ship on an electronic nautical chart. Further, the ECDIS 8 may also display a scheduled route of the ship on the electronic nautical chart. A GNSS plotter may be used, instead of the ECDIS.

The radio communication unit 9 may include radio equipment for realizing a stand-on/give-way determination communication with another ship or a land control, for example, utilizing a microwave, an ultrashort wave, an intermediate wave, or a shortwave.

The navigation controller 10 may be a control device for realizing autopilot, which controls a rudder of the ship. The navigation controller 10 may control an engine of the ship.

Although in this embodiment the ship monitoring device 1 is an independent device, it may be integrated with another device, such as the ECDIS 8. That is, the functional part of the ship monitoring device 1 may be realized by other devices.

Note that, although in this embodiment the ship monitoring device 1 is mounted on the ship and is used in order to monitor other ships which exist around the ship, the application is not limited to this. For example, the ship monitoring device 1 may be installed in a land control, and may be used in order to monitor ships which exist in a controlled ocean space.

Meanwhile, the Act on Preventing Collisions at Sea specifies whether each one of two ships in an overtaking relationship, a head-on relationship, or a crossing relationship should act as a stand-on ship or a give-way ship (Rules 11 to 18).

However, regarding the determination of whether it is a stand-on ship or a give-way ship, the rules only say “the section applies to vessels in sight of one another,” and do not specify any concrete determination timing.

For this reason, even if one of the two ships is determined to correspond to a stand-on ship or a give-way ship, the other ship may not yet be determined to correspond to the encounter relationship. Thus, if the determination timing differs between the two ships, concern will arise in recognition of the opponent ship, and there is a possibility of leading to unnecessary navigation.

Therefore, in this embodiment, by performing the stand-on/give-way determination by using the following technique, determination criteria are clarified and uniformed to solve those problems.

FIG. 2 is a block diagram illustrating one example of a configuration of the ship monitoring device 1. Processing circuitry 20 of the ship monitoring device 1 may include a the-ship data acquirer 21, an other-ships data acquirer 22, an encounter relationship determinator 23, and a stand-on/give-way determinator 24. These functional parts may be realized by The processing circuitry 20 of the ship monitoring device 1 performing information processing according to the program.

The-ship data acquirer 21 may acquire ship data indicative of the position and the velocity of the ship. The-ship data acquirer 21 is one example of a first data acquirer, and the-ship data is one example of first ship data. In detail, the-ship data acquirer 21 may successively acquire the position of the ship detected by the GNSS receiver 6, and the heading of the ship detected by the gyrocompass 7. The ship speed of the ship may be calculated based on a temporal change in the position of the ship, or may be acquired from a ship speed meter.

The other-ships data acquirer 22 may acquire other-ships data indicative of a position and a velocity of another ship. The other-ships data acquirer 22 is one example of a second data acquirer, and the other-ships data is one example of second ship data. The other-ships data may be generated based on data detected by the radar 3, the AIS 4, or the camera 5 which are mounted on the ship.

In detail, the other-ships data acquirer 22 may successively acquire the TT data generated by the radar 3, the AIS data received by the AIS 4, or identification data discriminated from the image captured by the camera 5, as other-ships data. The other-ships data acquirer 22 may register the acquired other-ships data into an other-ships management database established in the memory.

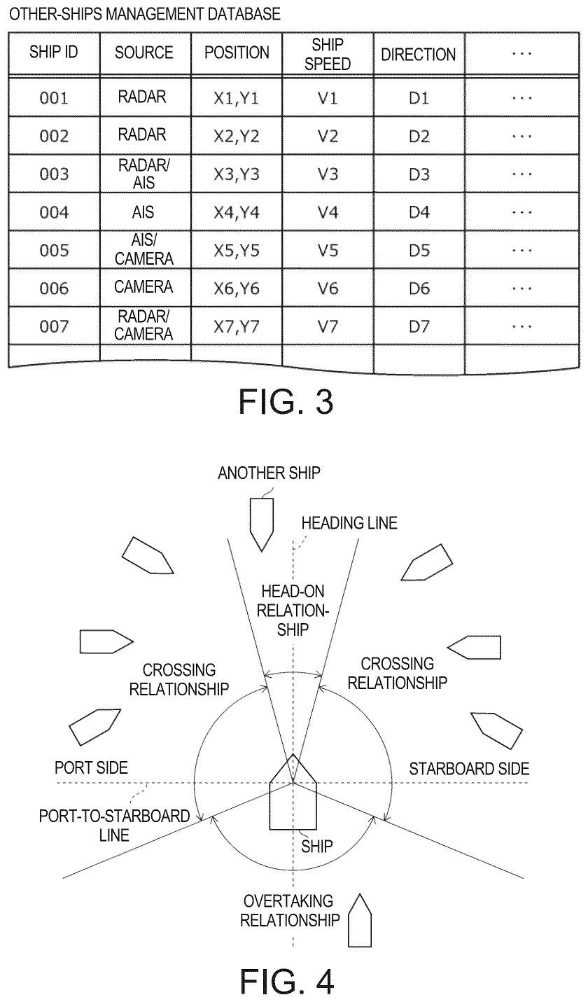

As illustrated in FIG. 3, the other-ships management database may include fields, such as “Ship ID,” “Source,” “Position,” “Ship speed,” and “Direction.” “Ship ID” may be an identifier given to another ship. “Source” may indicate a source of other-ships data (i.e., which one of the radar 3, the AIS 4, and any of camera 5 detected another ship).

“Position” may indicate the position of another ship. The position of another ship may be expressed by latitude and longitude. Since the position of another ship contained in the other-ships data from the radar 3 or the camera 5 is expressed by a relative position with respect to the ship, it may be converted into an absolute position by using the position of the ship detected by the GNSS receiver 6.

“Ship speed” may indicate the ship speed of another ship. “Direction” may indicate the heading of another ship. The ship speed and the direction of another ship which are contained in the other-ships data from the radar 3 or the camera 5 may be estimated based on a temporal change in the position of another ship.

Note that, when the position contained in other-ships data of which the source is one of the AIS 4, the radar 3, and the cameras, and the position contained in other-ships data of which the source is another one of the AIS 4, the radar 3, and the cameras 5 are identical or close to each other, the records may be integrated into one record because those other-ships data are related to another ship which is common.

Returning to FIG. 2, the encounter relationship determinator 23 may determine, based on the-ship data acquired by the-ship data acquirer 21 and the other-ships data acquired by other-ships data acquirer 22, whether the encounter relationship between the ship and another ship is the head-on relationship, the crossing relationship, or the overtaking relationship. In detail, the encounter relationship determinator 23 may calculate a course difference between the ship and another ship, and classify the encounter relationship based on the position and the course difference of another ship with respect to the ship.

FIG. 4 is a view illustrating various encounter relationships between the ship and another ship. The encounter relationships may be the head-on relationship, the crossing relationship, and the overtaking relationship.

The head-on relationship is a relationship in which the ship and another ship approach each other head on or almost head on. For example, when another ship is located ahead of the ship, and the course of another ship is opposite from the course of the ship (the course difference is about)180°, this encounter relationship may be determined to be the head-on relationship.

The overtaking relationship is a relationship in which another ship passes or overtakes the ship from behind. Behind the ship may be within a range which exceeds the port-to-starboard line toward aft by 22.5° (i.e., from 112.5° to 247.5°), for example. For example, when another ship is located behind the ship, and the course of another ship is close to the course of the ship, this encounter relationship may be determined to be the overtaking relationship.

The crossing relationship is a relationship in which one of the ship and another ship crosses the course of the other. For example, when another ship is located within a range on the port side of the ship and the course of another ship is to the starboard side of the ship, or when another ship is located on the starboard side of the ship and the course of another ship is to the port side of the ship, this relationship may be determined to be the crossing relationship.

Returning to FIG. 2, the stand-on/give-way determinator 24 may determine, based on the-ship data acquired by the-ship data acquirer 21, other-ships data acquired by the other-ships data acquirer 22, and the encounter relationship determined by the encounter relationship determinator 23, whether the ship or another ship corresponds to a stand-on ship or a give-way ship, or corresponds to neither (hereinafter, referred to as “stand-on/give-way determination”).

Note that, in the stand-on/give-way determination, when one of the ship and another ship is determined to be a stand-on ship or a give-way ship, the other may be also determined to be a stand-on ship or a give-way ship at the same time.

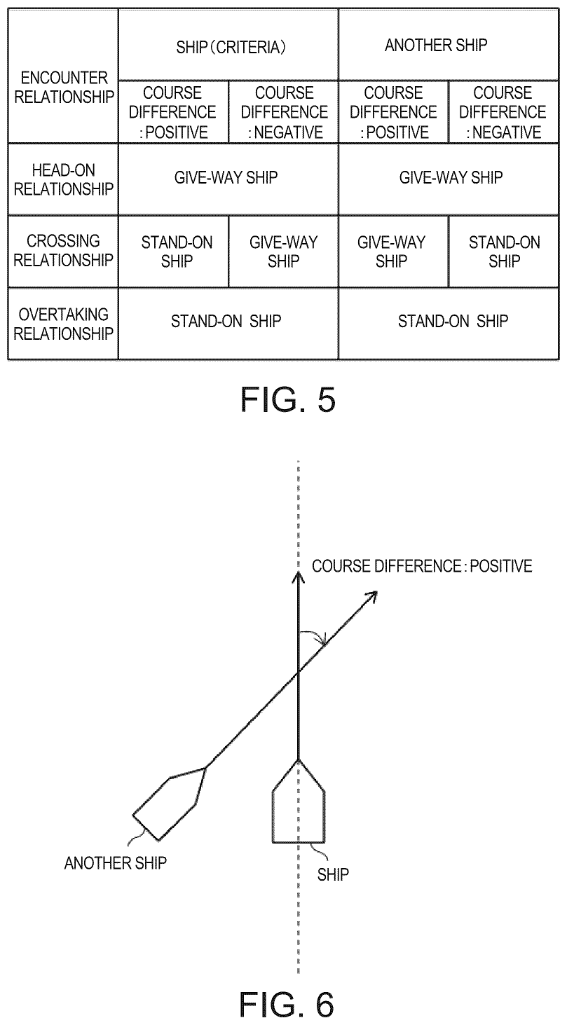

FIG. 5 is a table illustrating various relationships between a stand-on ship and a give-way ship. FIG. 6 is a view illustrating positive/negative of the course difference. When the course of another ship is offset in the clockwise direction with respect to the course of the ship, the course difference is a “positive” value, and when the course of another ship is offset in the counterclockwise direction with respect to the course of the ship, the course difference is a “negative” value.

The case where the course of another ship is offset in the clockwise direction with respect to the course of the ship may be a case where another ship approaches the ship from the port side (i.e., another ship sees the ship at the starboard side). The case where the course of another ship is offset in the counterclockwise direction with respect to the course of the ship may be a case where another ship approaches the ship from the starboard side (i.e., the ship sees another ship at the starboard side).

In the case of the head-on relationship, both the ship and another ship may be “give-way ships,” regardless of the course difference being positive or negative.

When the course difference is positive in the crossing relationship (i.e., when another ship sees the ship at the starboard side), the ship may be a “stand-on ship” and another ship may be a “give-way ship.”

Contrary to this, when the course difference is negative in the crossing relationship (i.e., when the ship sees another ship at the starboard side), the ship may be a “give-way ship” and another ship may be a “stand-on ship.”

In the case of the overtaking relationship, the ship may be a “stand-on ship” and another ship may be a “give-way ship,” regardless of the course difference being positive or negative.

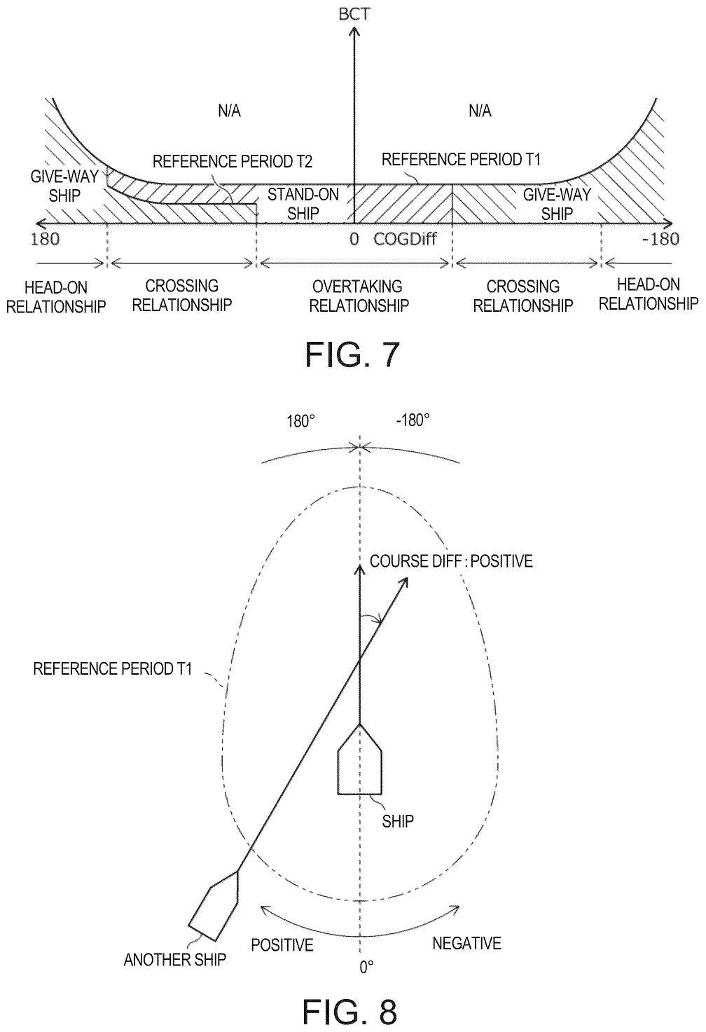

Below, the details of the stand-on/give-way determination by the stand-on/give-way determinator 24 is described using FIGS. 7 to 10. The stand-on/give-way determinator 24 may determine that each of the ship and another ship corresponds to a stand-on ship or a give-way ship, when an index indicative of approach of another ship to the ship reaches a given criteria.

The index indicative of approach of another ship to the ship may be time until another ship crosses the heading line of the ship (BCT: Bow Crossing Time), for example. Alternatively, time until another ship approach the ship the most (TCPA: Time to Closest Point of Approach) may be used. Alternatively, the index indicative of approach of another ship to the ship may be a distance between the ship and another ship, for example.

The criteria may be defined according to the course difference between the ship and another ship. That is, the criteria may be defined for every course difference between the ship and another ship, and the criteria may also change with a change in the course difference within at least some range of the course difference.

In detail, the stand-on/give-way determinator 24 may determine that each of the ship and another ship corresponds to a stand-on ship or a give-way ship, when BCT becomes shorter than a reference period T1, or when the ship-to-ship distance becomes shorter than a reference distance D1. On the other hand, the stand-on/give-way determinator 24 may determine that the ship and another ship corresponds to neither of a stand-on ship and a give-way ship, when BCT exceeds the reference period T1, and when the ship-to-ship distance exceeds the reference distance D1.

Although in this embodiment it is determined whether each ship corresponds to a stand-on ship or a give-way ship by using a logical sum of a condition related to BCT and a condition related to the ship-to-ship distance, it may be determined alternatively by using a logical multiply of the two conditions, or by using only one of the two conditions.

FIG. 7 is a graph illustrating various relationships between the course difference between the ship and another ship (COGdiff: Course Over Ground Difference), and reference periods T1 and T2 of BCT. Since the encounter relationship approximately corresponds to the course difference, relationships between the course difference and the encounter relationship are also illustrated in FIG. 7. FIG. 8 illustrates an imaginary frame indicative of the reference period T1 which encloses the ship in order to make the relationship between the course difference and the reference period T1 intelligible.

As illustrated in FIG. 7, the reference period T1 may increase with the increase in the course difference within some range where the course difference is large. Within a range where the course difference is smaller than this range, the reference period T1 may be constant. Therefore, as illustrated in FIG. 8, the frame indicative of the reference period T1 may be extended forward of the ship, and the timing of determination of a stand-on ship or a give-way ship may become earlier as the course difference increases.

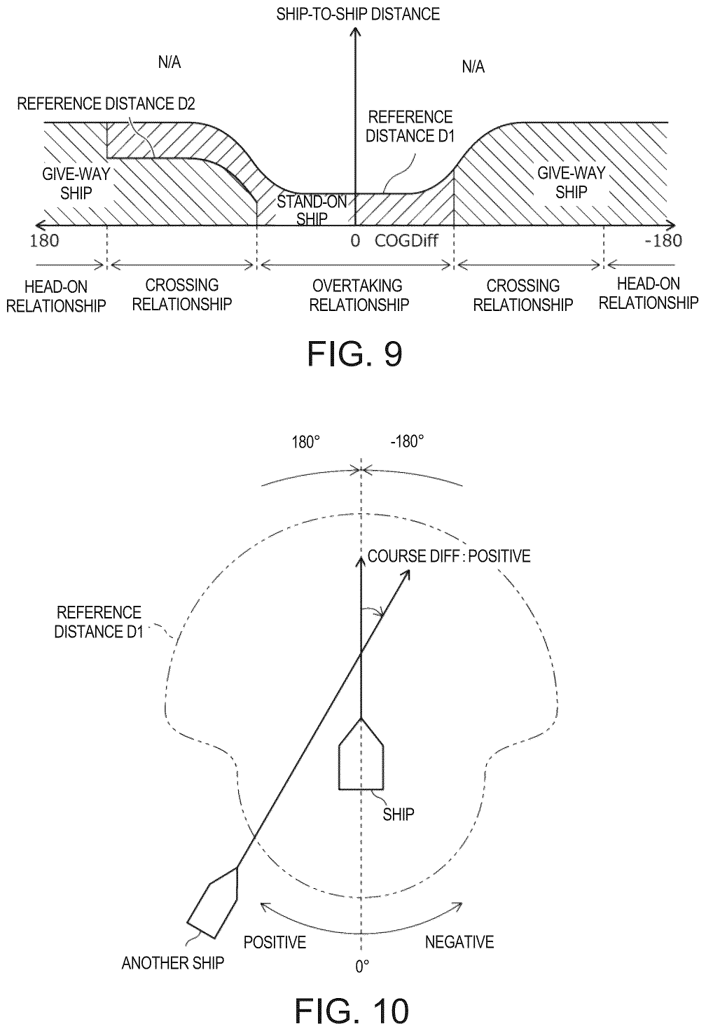

The relationship between the course difference and the reference period T1 is not limited to this example. For example, the reference period T1 may increase with the increase in the course difference in the whole range of the course difference, or the reference period T1 may increase in a stepwise fashion with the increase in the course difference, like the reference distance D1 described below (see FIG. 9).

The stand-on/give-way determinator 24 may determine that the ship corresponds to a give-way ship, when the encounter relationship becomes the head-on relationship and BCT becomes shorter than the reference period T1. At this time, another ship may also be determined to be a give-way ship.

The stand-on/give-way determinator 24 may determine that the ship corresponds to a give-way ship, when the encounter relationship becomes the crossing relationship in which the ship sees another ship at the starboard side (i.e., the crossing relationship in which the course difference is negative), and BCT becomes shorter than the reference period T1. At this time, another ship may be determined to be a stand-on ship.

The stand-on/give-way determinator 24 may determine that the ship corresponds to a stand-on ship, when the encounter relationship becomes the overtaking relationship and BCT becomes shorter than the reference period T1. At this time, another ship may be determined to be a give-way ship.

The stand-on/give-way determinator 24 may determine that the ship corresponds to a stand-on ship, when the encounter relationship becomes the crossing relationship in which the ship sees another ship at the port side (i.e., the crossing relationship in which the course difference is positive) and BCT becomes shorter than the reference period T1. At this time, another ship may be determined to be a give-way ship.

Alternatively, the stand-on/give-way determinator 24 may determine that the ship corresponds to a give-way ship, when BCT further decreases after it once determines that the ship corresponds to a stand-on ship to become shorter than the reference period T2 which is shorter than the reference period T1. That is, when the ship is once determined to be a stand-on ship and another ship is determined to be a give-way ship but another ship does not give way the course or does not evade the ship and further approaches the ship to further lower BCT, the determination result may be changed from a stand-on ship to a give-way ship.

Although in this embodiment the reference period T2 for changing from a stand-on ship to a give-way ship is set only when the encounter relationship is the crossing relationship in which the ship sees another ship at the port side (i.e., the crossing relationship in which the course difference is positive), the reference period T2 may be set in the overtaking relationship.

FIG. 9 is a graph illustrating various relationships between the course difference between the ship and another ship (COGdiff), and reference distances D1 and D2 of the ship-to-ship distance. Since the encounter relationship approximately corresponds to the course difference, FIG. 9 also illustrates relationships between the course difference and the encounter relationship. FIG. 10 illustrates an imaginary frame indicative of the reference distance D1 which encloses the ship in order to make the relationships between the course difference and the reference distance D1 intelligible.

As illustrated in FIG. 9, the reference distance D1 may increase with the increase in the course difference within some range where the course difference is about medium. Within ranges where the course difference is larger and smaller than this range, respectively, the reference distance D1 may be constant. That is, the reference distance D1 may increase in a stepwise fashion with the increase in the course difference. Therefore, as illustrated in FIG. 10, the frame indicative of the reference distance D1 may increase in the size at the front part rather than the rear part, and the timing of determination of a stand-on ship or a give-way ship may become earlier as the course difference increases.

The relationship between the course difference and the reference distance D1 is not limited to this example. For example, the reference distance D1 may increase with the increase in the course difference within the whole range of the course difference, or the reference distance D1 may increase exponentially within the range where the course difference is large, like the reference period T1 described above (see FIG. 7).

The stand-on/give-way determinator 24 may determine that the ship corresponds to a give-way ship, when the encounter relationship becomes the head-on relationship and the ship-to-ship distance becomes less than the reference distance D1. At this time, another ship may also be determined to be a give-way ship.

the stand-on/give-way determinator 24 may determine that the ship corresponds to a give-way ship, when the encounter relationship becomes the crossing relationship in which the ship sees another ship at the starboard side (i.e., the crossing relationship in which the course difference is negative) and the ship-to-ship distance becomes less than the reference distance D1. At this time, another ship is determined to be a stand-on ship.

The stand-on/give-way determinator 24 may determine that the ship corresponds to a stand-on ship, when the encounter relationship becomes the overtaking relationship and the ship-to-ship distance becomes less than the reference distance D1. At this time, another ship may be determined to be a give-way ship.

The stand-on/give-way determinator 24 may determine that the ship corresponds to a stand-on ship, when the encounter relationship becomes the crossing relationship in which the ship sees another ship at the port side (i.e., the crossing relationship in which the course difference is positive) and the ship-to-ship distance becomes less than the reference distance D1. At this time, another ship may be determined to be a give-way ship.

Alternatively, the stand-on/give-way determinator 24 may determine that the ship corresponds to a give-way ship, when the ship-to-ship distance further decreases after it once determines that the ship corresponds to a stand-on ship to become less than the reference distance D2 which is shorter than the reference distance D1. That is, when the ship is once determined to be a stand-on ship and another ship is determined to be a give-way ship but another ship does not give way the course or does not evade the ship and further approaches the ship to further decrease the ship-to-ship distance, the determination result may be changed from a stand-on ship to a give-way ship.

Although in this embodiment the reference distance D2 for changing from a stand-on ship to a give-way ship is set only when the encounter relationship is the crossing relationship in which the ship sees another ship at the port side (i.e., the crossing relationship in which the course difference is positive), the reference distance D2 may also be set in the overtaking relationship.

Note that the stand-on/give-way determinator 24 may use a criteria of whether another ship approaches the ship, in addition to the criteria described above. That is, the stand-on/give-way determinator 24 may determine that each of the ship and another ship corresponds to a stand-on ship or a give-way ship, when BCT becomes shorter than the reference period T1 or when the ship-to-ship distance becomes less than the reference distance D1, and when another ship approaches the ship.

On the other hand, the stand-on/give-way determinator 24 may determine that neither of the ship and another ship corresponds to a stand-on ship or a give-way ship, when another ship gets away or leaves from the ship, even if BCT becomes shorter than the reference period T1, or even if the ship-to-ship distance becomes less than the reference distance D1.

The approach of another ship to the ship may be determined based on positive/negative of TCPA. TCPA becomes a positive value when another ship is approaching the ship, and TCPA becomes a negative value when another ship is getting away from the ship.

In this case, after the encounter relationship is solved or over (for example, after evaded from the head-on situation, after crossing, or after overtaking), since it is determined that neither of the ship and another ship corresponds to a stand-on ship or a give-way ship, the encounter relationship determinator 23 may determine the encounter relationship only based on the course difference between the ship and another ship, without taking the positions of the ship and another ship into consideration.

Alternatively, the stand-on/give-way determinator 24 may determine that neither of the ship and another ship corresponds to a stand-on ship or a give-way ship after the ship or another ship is determined to be a give-way ship and it takes an evasive action, even if BCT becomes shorter than the reference period T1 or the ship-to-ship distance becomes less than the reference distance D1.

The fact that the ship or another ship took an evasive action may be determined based on a change in the course difference between the ship and another ship (COGdiff), a change in BCT or the ship-to-ship distance to N/A (not applicable) side, etc.

Also in this case, after the ship or another ship took an evasive action, since neither of the ship and another ship is determined to be a stand-on ship or a give-way ship, the encounter relationship determinator 23 may determine the encounter relationship only based on the course difference between the ship and another ship, without taking the positions of the ship and another ship into consideration.

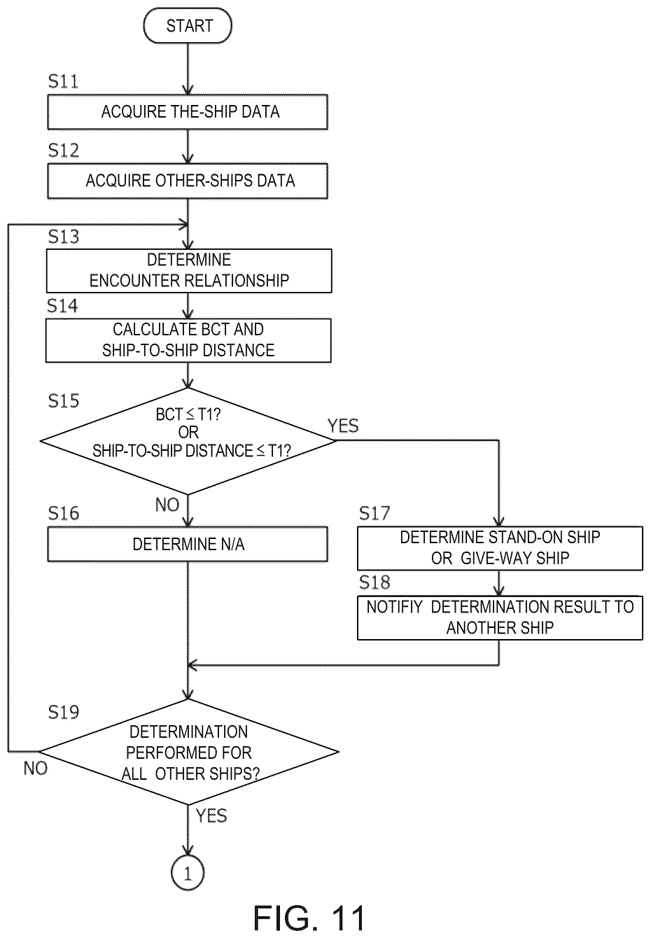

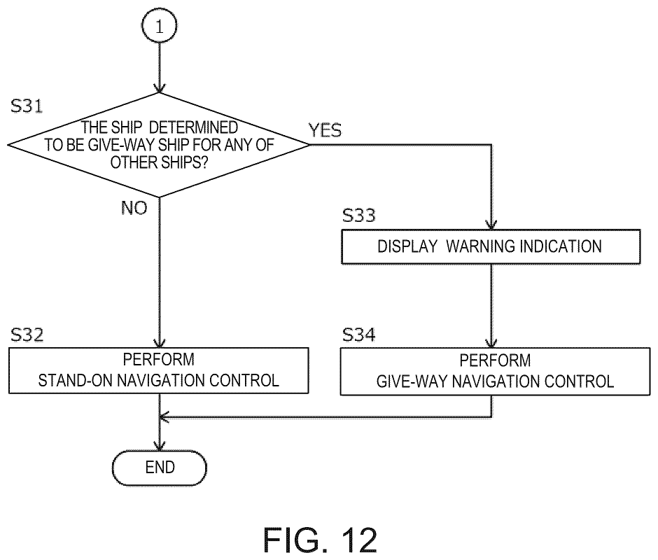

FIGS. 11 and 12 illustrate a flowchart illustrating one example of a procedure of the ship monitoring method according to this embodiment realized in the ship monitoring system 100. The ship monitoring device 1 may perform information processing illustrated in the flowchart according to the program.

As illustrated in FIG. 11, the ship monitoring device 1 may first acquire the-ship data (S11: processing as the the-ship data acquirer 21).

Next, the ship monitoring device 1 may acquire other-ships data (S12: processing as the other-ships data acquirer 22). Here, the ship monitoring device 1 may acquire other-ships data of a plurality of other ships which exist around the ship, and carry out the following determination for each of other ships.

Next, the ship monitoring device 1 may determine the encounter relationship between the ship and another ship based on the the-ship data and the other-ships data (S13; processing as the encounter relationship determinator 23). The encounter relationship between the ship and another ship may be classified into the head-on relationship, the crossing relationship, and the overtaking relationship.

Next, the ship monitoring device 1 may calculate the time until another ship crosses the heading line of the ship (BCT) and the ship-to-ship distance between the ship and another ship based on the the-ship data and the other-ships data (S14), and perform the stand-on/give-way determination (S15-S17: processing as the stand-on/give-way determinator 24).

In detail, the ship monitoring device 1 may determine whether BCT is shorter than the reference period T1 or the ship-to-ship distance is shorter than the reference distance D1 (S15).

If BCT exceeds the reference period T1 and the ship-to-ship distance exceeds the reference distance D1 (S15: NO), the ship monitoring device 1 may determine that neither of the ship and another ship corresponds to a stand-on ship or a give-way ship (S16).

If BCT is shorter than the reference period T1 or the ship-to-ship distance is shorter than the reference distance D1 (S15: YES), the ship monitoring device 1 may determine whether each of the ship and another ship corresponds to a stand-on ship or a give-way ship (S17).

In detail, as described above, both the ship and another ship may be determined to be “give-way ships” in the head-on relationship, the ship may be determined to be the “stand-on ship” and another ship may be determined to be the “give-way ship” in the crossing relationship in which the course difference is positive, the ship may be determined to be the “give-way ship” and another ship may be determined to be the “stand-on ship” in the crossing relationship in which the course difference is negative, and the ship may be determined to be the “stand-on ship” and another ship may be determined to be the “give-way ship” in the overtaking relationship.

Note that, in the crossing relationship in which the course difference is positive, the ship may be determined to be the “give-way ship” when BCT is shorter than the reference period T2 which is shorter than the reference period T1, or the ship-to-ship distance is shorter than the reference distance D2 which is shorter than the reference distance D1 (see FIGS. 7 and 9).

Next, the ship monitoring device 1 may notify a determination result to another ship (S18). The determination result may be transmitted to another ship by the radio communication unit 9 as a notice transmitter. Therefore, regarding whether each of the ship and another ship corresponds to a stand-on ship or a give-way ship, the ship can share the own recognition and timing with another ship.

The ship monitoring device 1 may perform processings of S13-S18 described above for all the detected other ships (S19). When the determination is performed for all the other ships (S19: YES), the ship monitoring device 1 may transit to the processing illustrated in FIG. 12.

As illustrated in FIG. 12, the ship monitoring device 1 may determine whether the ship is determined to be a give-way ship with respect to any of other ships (S31).

If the ship is not determined to be a give-way ship with respect to any of other ships (i.e., if the ship is determined to be a stand-on ship or N/A with respect to all the other ships) (S31: NO), the ship monitoring device 1 may make the navigation controller 10 perform a stand-on navigation control (S32). In this case, the navigation controller 10 may navigate the ship so that the velocity is maintained. That is, the navigation controller 10 may control a rudder, an engine, etc. so that the ship speed and the heading of the ship are maintained.

On the other hand, if the ship is determined to be a give-way ship with respect to any of other ships (S31: YES), the ship monitoring device 1 may display a warning indication illustrating that the ship is a give-way ship on the display unit 2 (S33), and make the navigation controller 10 perform a give-way navigation control (S34). In this case, the navigation controller 10 may navigate the ship so as to avoid the course of another ship. In detail, the navigation controller 10 may change the ship speed and the heading so as to avoid a collision risk area with another ship.

Note that an advance warning indication illustrating in advance that the ship can become a give-way ship may be displayed, in addition to the warning indication illustrating that the ship is a give-way ship. For example, among the criteria illustrated in FIG. 7 or FIG. 9 (the reference period or the reference distance), a preliminary criteria may be provided on the N/A side of the part corresponding to a give-way ship, and the advance warning indication may be displayed when the index indicative of approach (BCT or the ship-to-ship distance) becomes less than the preliminary criteria.

According to this embodiment, the criteria is clarified and normalized by performing the stand-on/give-way determination described above, thereby suppressing the determination timing lag between the ship and another ship.

Although the embodiment of the present disclosure is described above, the present disclosure is not limited to the above embodiment, and it is needless to say that various changes and modifications may be possible for the person skilled in the art.

For example, when the ship type of another ship discriminated based on the AIS data is a fishing boat, the ship monitoring device 1 may always determine that the ship corresponds to a give-way ship, without using the classification illustrated in FIG. 5.

Alternatively, the ship monitoring device 1 may use a variable criteria which varies according to the ship type or the ship length of the ship or another ship. Since generally the navigation response becomes slower as a ship concerned becomes larger, the criteria may be enlarged as the ship or another ship increases in the size to give some margin to BCT and the ship-to-ship distance in the determination.

The criteria may be variable according to hydrographic or oceanographic condition. Since generally low visibility arises according to rain or fog during stormy weather and navigation becomes difficult due to high ocean waves, the criteria may be enlarged as the hydrographic condition gets worse to give the margin to BCT and the ship-to-ship distance in the determination.

Alternatively, the criteria may be variable according to a geographical position at which the ship travels. Since generally the traveling route is limited in a water channel and on a sea lane, the criteria may be made smaller when the ship travels in the water channel or on the sea lane to give priority to the regulation conformity.

Alternatively, the ship monitoring device 1 may accept a change in the criteria by a user. Alternatively, when the ship monitoring device 1 accepts the change in the criteria by the user, it may generate a learned model by using the changed criteria, and a ship type, a ship length, a hydrographic condition, or a geographical position, as teaching data to acquire a criteria suitable for the ship type, the ship length, the hydrographic condition, or the geographical position.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### DESCRIPTION OF REFERENCE CHARACTERS

1 Ship Monitoring Device
2 Display Unit
3 Radar
4 AIS
5 Camera
6 GNSS Receiver
7 Gyrocompass
8 ECDIS
9 Radio Communication Unit
10 Navigation Controller
20 Controller
21 The-ship Data Acquirer
22 Other-ships Data Acquirer
23 Encounter Relationship Determinator
24 Stand-on/Give-way Determinator
100 Ship Monitoring System

What is claimed is:

1. A ship monitoring device, comprising:
processing circuitry configured to;
acquire first ship data indicative of a position and a velocity of a first ship,
acquire second ship data indicative of a position and a velocity of a second ship,
determine whether an encounter relationship between the first ship and the second ship is any one of a head-on relationship, a crossing relationship, and an overtaking relationship based on the first ship data and the second ship data, and
determine whether at least one of the first ship and the second ship corresponds to a stand-on ship, a give-way ship, or corresponds to neither thereof based on the first ship data, the second ship data, and the encounter relationship.

2. The ship monitoring device of claim 1, wherein the processing circuitry determines that the first ship corresponds to a stand-on ship or a give-way ship, when an index indicative of approach of the second ship to the first ship reaches a given criteria.

3. The ship monitoring device of claim 1, wherein the processing circuitry performs the determination using a criteria defined according to a course difference between the first ship and the second ship.

4. The ship monitoring device of claim 1, wherein the processing circuitry determines that the first ship corresponds to a stand-on ship or a give-way ship, when a time until the second ship crosses a heading line of the first ship, or a time until the second ship approaches the first ship the closest becomes less than a reference period defined according to a course difference between the first ship and the second ship, or when a distance between the first ship and the second ship becomes less than a reference distance defined according to the course difference between the first ship and the second ship.

5. The ship monitoring device of claim 2, wherein the processing circuitry determines that the first ship corresponds to a stand-on ship or a give-way ship, when a time until the second ship crosses a heading line of the first ship, or a time until the second ship approaches the first ship the closest becomes less than a reference period defined according to a course difference between the first ship and the second ship, or when a distance between the first ship and the second ship becomes less than a reference distance defined according to the course difference between the first ship and the second ship.

6. The ship monitoring device of claim 3, wherein the processing circuitry determines that the first ship corresponds to a stand-on ship or a give-way ship, when a time until the second ship crosses a heading line of the first ship, or a time until the second ship approaches the first ship the closest becomes less than a reference period defined according to a course difference between the first ship and the second ship, or when a distance between the first ship and the second ship becomes less than a reference distance defined according to the course difference between the first ship and the second ship.

7. The ship monitoring device of claim 4, wherein the processing circuitry determines that the first ship corresponds to neither of a stand-on ship and a give-way ship, when the time exceeds the reference period and when the distance exceeds the reference distance.

8. The ship monitoring device of claim 5, wherein the processing circuitry determines that the first ship corresponds to neither of a stand-on ship and a give-way ship, when the time exceeds the reference period and when the distance exceeds the reference distance.

9. The ship monitoring device of claim 6, wherein the processing circuitry determines that the first ship corresponds to neither of a stand-on ship and a give-way ship, when the time exceeds the reference period and when the distance exceeds the reference distance.

10. The ship monitoring device of claim 4, wherein at least one of the reference period and the reference distance increases with an increase in the course difference within at least a part of the whole range of the course difference.

11. The ship monitoring device of claim 4, wherein the processing circuitry determines that the first ship corresponds to a give-way ship, when the encounter relationship is the head-on relationship, or is the crossing relationship in which the first ship sees the second ship at the starboard side, and the time becomes less than the reference period or the distance becomes less than the reference distance.

12. The ship monitoring device of claim 4, wherein the processing circuitry determines that the first ship corresponds to a stand-on ship, when the encounter relationship is the overtaking relationship, or is the crossing relationship in which the first ship sees the second ship at the port side, and the time becomes less than the reference period or the distance becomes less than the reference distance.

13. The ship monitoring device of claim 8, wherein the processing circuitry determines that the first ship corresponds to a give-way ship, when the encounter relationship is the overtaking relationship, or is the crossing relationship in which the first ship sees the second ship at the port side, and the time becomes less than another reference period shorter than the reference period or the distance becomes less than another reference distance shorter than the reference distance.

14. The ship monitoring device of claim 1, further comprising a navigation controller adapted to navigate the first ship so that the velocity of the first ship is maintained, when the first ship is determined to be a stand-on ship.

15. The ship monitoring device of claim 1, further comprising a navigation controller adapted to navigate the first ship so that the first ship avoid the course of the second ship, when the first ship is determined to be a give-way ship.

16. The ship monitoring device of claim 1, further comprising a notice transmitter configured to notify the determination result to the second ship, when the first ship is determined to be a stand-on ship or a give-way ship.

17. The ship monitoring device of claim 1, wherein the second ship data is generated based on data detected by a radar, an AIS, or a camera mounted on the first ship.

18. A ship monitoring method, comprising the steps of:
acquiring first ship data indicative of a position and a velocity of a first ship;
acquiring second ship data indicative of a position and a velocity of a second ship;
determining, based on the first ship data and the second ship data, whether an encounter relationship between the first ship and the second ship is any one of a head-on relationship, a crossing relationship, and an overtaking relationship; and
determining, based on the first ship data, the second ship data, and the encounter relationship, whether at least one of the first ship and the second ship corresponds to a stand-on ship, a give-way ship, or neither thereof.

19. A non-transitory computer-readable recording medium storing a program for causing a computer to execute processing, the processing comprising:
acquiring first ship data indicative of a position and a velocity of a first ship;
acquiring second ship data indicative of a position and a velocity of a second ship;
determining, based on the first ship data and the second ship data, whether an encounter relationship between the first ship and the second ship is any one of a head-on relationship, a crossing relationship, and an overtaking relationship; and
determining, based on the first ship data, the second ship data, and the encounter relationship, whether at least one of the first ship and the second ship corresponds to a stand-on ship, a give-way ship, or neither thereof.
